(19) United States
(12) Patent Application Publication
(10) Pub. No.: US 2025/0111197 A1
(43) Pub. Date: Apr. 3, 2025

(54) TRAINING NEURAL NETWORKS TO PERFORM MACHINE LEARNING TASKS

(71) Applicant: Google LLC, Mountain View, CA (US)

(72) Inventors: Yaqing Wang, Jersey City, NJ (US); Jialin Wu, Culver City, CA (US)

(21) Appl. No.: 18/900,520

(22) Filed: Sep. 27, 2024

Related U.S. Application Data
(60) Provisional application No. 63/586,408, filed on Sep. 28, 2023.

(51) Int. Cl. G06N 3/045; G06F 40/284; G06V 10/26; G06V 10/32; G06V 10/82

(52) U.S. Cl. CPC G06N 3/045; G06F 40/284; G06V 10/26; G06V 10/32; G06V 10/82

(57) ABSTRACT

Methods, systems, and apparatus, including computer programs encoded on a computer storage medium, for performing a machine learning task. One of the methods includes obtaining data specifying a pre-trained neural network; obtaining a plurality of training examples for one or more new machine learning tasks; and generating a new neural network for the one or more new machine learning tasks.

### CROSS-REFERENCE TO RELATED APPLICATION

This application claims priority to U.S. Provisional Application No. 63/586,408, filed on Sep. 28, 2023. The disclosure of the prior application is considered part of and is incorporated by reference in the disclosure of this application.

### BACKGROUND

This specification relates to performing a machine learning task on a network input using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that generates a neural network that performs a machine learning task.

According to one aspect there is provided a method comprising: obtaining data specifying a pre-trained neural network, wherein the pre-trained neural network comprises an embedding layer and a task neural network, wherein the pre-trained neural network has been pre-trained to perform one or more machine learning tasks, and wherein the pre-trained neural network is configured to: receive input data; generate one or more embedded representations for the input data using the embedding layer; process an input sequence comprising the one or more embedded representations using the task neural network to generate an output for the one or more machine learning tasks; obtaining a plurality of training examples for one or more new machine learning tasks; generating a new neural network for the one or more new machine learning tasks, wherein the new neural network comprises one or more subnetworks, the embedding layer, and the task neural network, and wherein the one or more subnetworks are configured to: receive the one or more embedded representations; generate one or more transformed embeddings that have the same dimensionality as the one or more embedded representations; and provide the one or more transformed embeddings as input to the task neural network, and wherein generating the new neural network comprises training the new neural network on the plurality of training examples by training the one or more subnetworks while holding the embedding layer and the task neural network fixed.

In some implementations, the input data comprises a plurality of types of data, and wherein each of the one or more embedded representations corresponds to a type of data, and wherein each of the one or more subnetworks is configured to generate a transformed embedding for a corresponding type of data, and wherein each of the one or more subnetworks is configured to receive the embedded representation for the corresponding type of data.

In some implementations, the input to the task neural network comprises one or more transformed embeddings that have been concatenated with each other.

In some implementations, the plurality of types of data comprise: text data, image data, audio data, or video data.

In some implementations, the new machine learning task comprises any one of:
a visual question-answering task, an image captioning task, or a scene-text understanding task.

In some implementations, the pre-trained neural network is any one of: a vision language model, or a multimodal model.

In some implementations, each of the one or more subnetworks corresponds to a particular machine learning task of the one or more new machine learning tasks, and wherein each of the one or more subnetworks is configured to generate a transformed embedding for an embedded representation for input data that corresponds to the particular machine learning task, and wherein each of the one or more subnetworks is configured to receive the embedded representation for input data that corresponds to the particular machine learning task.

In some implementations, the one or more new machine learning tasks comprise: a natural language inference task, a sentiment task, a reading comprehension task, a commonsense reasoning task, a paraphrase task, a closed-book question answering task, or a coreference task.

In some implementations, the pre-trained neural network is any one of: a large language model, or a diffusion model.

In some implementations, each of the one or more subnetworks comprise two fully connected layers.

In some implementations, the pre-trained neural network has been trained using instruction tuning.

In some implementations, the embedding layer comprises any one or more of: a convolutional neural network, a Transformer neural network, or a vision Transformer (ViT) neural network.

In some implementations, each of the one or more subnetworks is configured to generate a particular transformed embedding for a corresponding embedded representation, and wherein each of the one or more subnetworks is configured to: project the corresponding embedded representation into a low-dimension representation, wherein the low-dimension representation has lower dimensionality than the corresponding embedded representation; project the low-dimension representation into a high-dimension representation, wherein the high-dimension representation has a same dimensionality as the corresponding embedded representation; and generate the particular transformed embedding for the corresponding embedded representation by combining the corresponding embedded representation with the high-dimension representation.

In some implementations, the input data comprises image data, and the embedding layer is configured to: for each image in the image data: resize the image to a particular resolution; separate the resized image into a plurality of non-overlapping patches; obtain a respective visual token for each non-overlapping patch; provide each respective visual token to a visual neural network that generates output tokens for the respective visual tokens; and generate a respective embedded representation for the image by flattening the output tokens from the visual neural network.

In some implementations, the input data comprises text data, and the embedding layer is configured to: obtain a sequence of tokens that represent the text data; and generate the embedded representation by obtaining an embedding for each token in the sequence of tokens.

According to another aspect there are provided one or more non-transitory computer storage media storing instructions that when executed by one or more computers cause the one or more computers to perform the operations of the methods described herein.

According to another aspect there is provided a system comprising: one or more computers; and one or more storage devices communicatively coupled to the one or more computers, wherein the one or more storage devices store instructions that, when executed by the one or more computers, cause the one or more computers to perform the operations of the methods described herein.

Particular embodiments of the subject matter described in this specification can be implemented so as to realize one or more of the following advantages.

The techniques described in this specification allow for fine-tuning a pre-trained neural network to perform different machine learning tasks. Fine-tuning a pre-trained neural network requires less computing time and resources than training a neural network to perform the machine learning task from scratch. In addition, a neural network can be finetuned to perform a task using fewer training examples than training the neural network from scratch. In particular, training a neural network with a large number of parameters to perform the machine learning task from scratch requires a large amount of computing time, resources, and training examples. Furthermore, training and maintaining different neural networks to perform different machine learning tasks also requires a large amount of computing time and resources. The described techniques, on the other hand, allow for fine-tuning the same neural network to perform multiple machine learning tasks.

Existing techniques for fine-tuning a pre-trained neural network may require adjusting the parameters of the neural network, or adjusting the internal architecture of the neural network. These existing techniques can introduce significant complexities in architecture design or compatibility issues. Directly changing the internal architecture of the neural network can lead to issues with serving infrastructure for existing common architectures. For example, directly changing the internal architecture of the neural network can complicate the serving infrastructure required for multi-use deployment where a single neural network is equipped with multiple adaptation components. Furthermore, directly changing the internal architecture can introduce significant complexities for training. For example, modifying existing layers and adding new layers can fundamentally alter the network's architecture and heightens the possibility of unintended behaviors, requiring extensive validation and testing to ensure model reliability. In addition, changes to the internal architecture can lead to compatibility issues with existing training pipelines and optimization techniques that were designed for the original network structure.

Some existing techniques for fine-tuning can adjust the behavior of a neural network with minimal changes to the internal architecture or parameters, e.g., by modifying the input to the internal architecture. However, these techniques may not easily be optimized, and may require a large number of training examples. In addition, these techniques may be less effective for large models or complex tasks such as multi-tasking and multimodal tasks. For example, existing techniques such as prompt tuning increase the sequence length of the input to the internal architecture.

The techniques described in this specification provide for fine-tuning a pre-trained neural network to generate a new neural network without adjusting the parameters of the neural network, while allowing for optimization and retaining high performance. For example, the techniques include using one or more subnetworks to process embeddings of input data. The subnetworks receive embeddings of input data as input, and output transformed embeddings that are provided to the task neural network of the pre-trained neural network. The techniques include generating the new neural network by training the one or more subnetworks while holding components of the pre-trained neural network, such as an embedding layer and a task neural network, fixed. Thus the parameters and internal architecture of the pre-trained neural network are not modified.

The techniques described in this specification allow for performing multimodal tasks. For example, the input data for a multimodal task can include multiple types of data. Each of the subnetworks can be associated with one type of data. The techniques include generating a transformed embedding for each type of data using a subnetwork associated with each type of data. Different modalities can be processed independently, allowing for greater flexibility and isolating interference across modalities.

The techniques described in this specification can also allow for performing multiple tasks using a single neural network. For example, each of the subnetworks can be associated with one particular task, allowing for adaptation to the nuances of each task while enabling positive knowledge transfer through the shared parameters of the pre-trained neural network. The techniques include generating a transformed embedding for input data for a particular task using a subnetwork that corresponds to the particular task. The techniques also allow for adapting to new scenarios or tasks without requiring changes to the parameters or architecture of the pre-trained neural network.

The techniques described in this specification are non-intrusive to the internal architecture, and are optimizable. For example, the added computational complexity grows linearly with model embedding dimension, invariant to other parameters. The techniques described in this specification do not require increasing the sequence length of the input to the task neural network, which would lead to an increase in computational complexity. The computational complexity of the techniques described in this specification remains invariant with the scaling of model layers of the pre-trained neural network. Furthermore, each of the subnetworks is associated with one type of data or one task, minimizing interference across types of data or across tasks. Thus the techniques described in this specification provide for customizable and scalable task adaptation while limiting complexity overhead and preserving model architecture, allowing for large-scale deployment.

In some implementations, the pre-trained neural network can have been trained on one or more machine learning tasks through instruction tuning. The techniques can fine-tune the pre-trained neural network to perform a new machine learning task using a smaller amount of adaptation parameters, facilitating the adaptation training process and resulting in improved performance on diverse machine learning tasks such as text and multimodal tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example training system for generating a new neural network.

FIG. 2 shows an example new neural network.

FIG. 3 shows another example new neural network.

FIG. 4 shows an example subnetwork.

FIG. 5 is a flow diagram of an example process for generating a new neural network.

Like reference numbers and designations in the various drawings indicate like elements.

### DETAILED DESCRIPTION

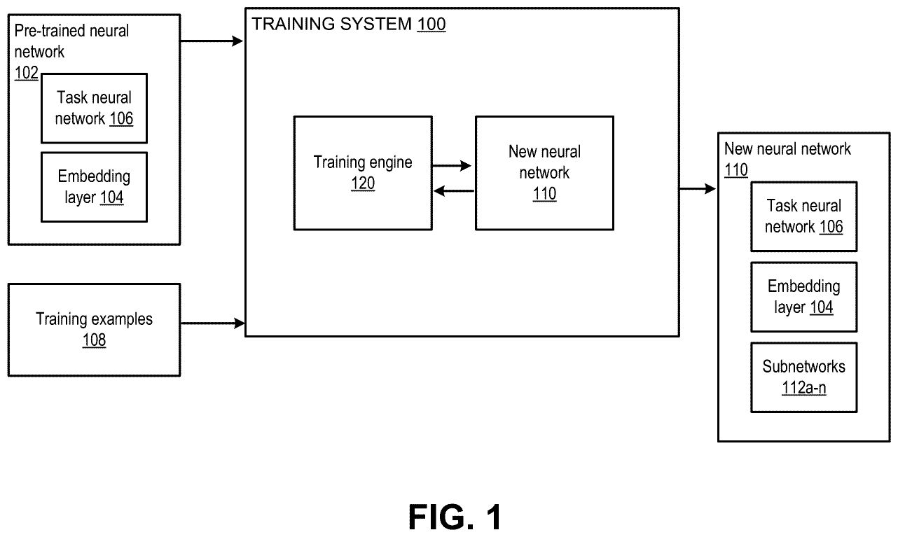

FIG. 1 shows an example training system 100. The training system 100 is an example of a system implemented as computer programs on one or more computers in one or more locations, in which the systems, components, and techniques described below can be implemented.

The system 100 can generate a new neural network 110 that performs a new machine learning task from a pre-trained neural network 102. For example, the system can obtain data specifying a pre-trained neural network 102 that has been pre-trained to perform one or more machine learning tasks. Data specifying the pre-trained neural network 102 can include trained values of parameters of the pre-trained neural network 102.

The system 100 can generate a new neural network 110 that performs one or more new machine learning tasks, e.g., one or more machine learning tasks that the pre-trained neural network 102 was not pre-trained to perform. Examples of machine learning tasks that can be performed by the pre-trained neural network 102, the new neural network 110, or both, are described below.

The pre-trained neural network 102 has a set of parameters and is configured to process a network input in accordance with the parameters to generate one or more outputs based on input data for one or more machine learning tasks. The pre-trained neural network 102 can have been pre-trained to perform one or more machine learning tasks, e.g., by the training system 100 or by another training system.

The neural network 102 can have any appropriate architecture that allows the neural network 102 to receive input data of the type required by the machine learning tasks and to generate outputs of the form required for the tasks. For example, the pre-trained neural network 102 can include a task neural network 106 and an embedding layer 104.

The pre-trained neural network 102 can be configured to receive input data. The pre-trained neural network 102 can generate one or more embedded representations for the input data using the embedding layer 104. In some examples, the embedding layer 104 can include one or more neural networks such as a convolutional neural network (CNN), a Transformer neural network, or a vision Transformer (ViT) neural network.

As a particular example, if the input data includes image data, the embedding layer 104 can receive, as input, an image, to generate an embedded representation of the image.

In some cases, the embedding layer 104 can include an image encoder neural network that has a convolutional neural network architecture that includes one or more convolutional layers.

In some cases, the embedding layer 104 can include an image encoder neural network that has a Transformer-based architecture that includes one or more attention layers.

In some cases, the embedding layer 104 can include an image encoder neural network that has a vision Transformer architecture. For example, the image encoder neural network can have one of the ViT architectures described in Dosovitskiy, A., et al. An image is worth 16×16 words: Transformers for image recognition at scale. arXiv preprint arXiv:2010.11929, 2020; Chen, X., et al. Pali: A jointly-scaled multilingual language-image model. arXiv preprint arXiv:2209.06794, 2022; and Chen, X., et al., Pali-x: On scaling up a multilingual vision and language model. arXiv preprint arXiv:2305.18565, 2023.

In some examples, for each image in the image data, the embedding layer 104 can resize the image to a particular resolution. The particular resolution can be a resolution for which the task neural network 106 has been trained to process. The embedding layer 104 can separate the resized image into multiple non-overlapping patches. The embedding layer 104 can obtain a respective visual token for each non-overlapping patch. For example, the embedding layer 104 can generate a patch embedding for each patch using a linear projection layer. In some examples, the embedding layer 104 can add position embeddings to the patch embeddings. The embedding layer 104 can use the patch embeddings as the respective visual tokens.

The embedding layer 104 can provide each respective visual token to a visual neural network, e.g., a Transformer encoder of a ViT, that generates output tokens for the respective visual tokens. The embedding layer 104 can generate a respective embedded representation for the image by flattening the output tokens from the visual neural network.

As another example, if the input data includes text data, the embedding layer 104 can receive, as input, text data, to generate an embedded representation of the text.

In some examples, the embedding layer 104 can obtain a sequence of tokens that represent the text data. For example, the embedding layer 104 can use a SentencePiece tokenizer to obtain a sequence of tokens for the text data that represent subword units. A subword may be a whole word, or may alternatively be a phoneme, syllable, part of a syllable, or any other such portion of the word that includes one or more characters. The embedding layer 104 can generate the embedded representation by obtaining an embedding for each token in the sequence of tokens. For example, the embedding layer can convert the sequence of tokens into continuous vectors.

For example, the embedding layer 104 can represent the text as a sequence of one-hot encoded vectors with a corresponding one-hot encoded vector for each subword, and then map each one-hot encoded vector to a continuous vector in accordance with a predefined mapping. In some examples, the predefined mapping is represented as an embedding matrix that has learned values, and thus to generate the embedded representation of the text, the embedding layer 104 determines a respective product of each one-hot encoded vector and the embedding matrix.

In other examples, the predefined mapping can be represented as a different learned module. For example, the different learned module can be a text encoder neural network. The text encoder neural network can have any appropriate neural network architecture, e.g., a feedforward architecture, e.g., an encoder-only Transformer neural network, or a recurrent architecture, that allows the neural network to map the text to the embedded representation of the text.

The pre-trained neural network 102 can process an input sequence that includes the one or more embedded representations using the task neural network 106 to generate an output for the one or more machine learning tasks. The task neural network 106 can have any appropriate architecture for processing an input sequence to generate an output for one or more machine learning tasks.

For example, the task neural network 106 can have any appropriate Transformer-based architecture, e.g., an encoder-only Transformer architecture, an encoder-decoder Transformer architecture, a decoder-only Transformer architecture, or another attention-based architecture, that includes one or more attention layers. As a particular example, the task neural network 106 can include one of the neural networks described in Chowdhery, A., et al. Palm: Scaling language modeling with pathways. arXiv preprint arXiv:2204.02311, 2022, Chen, X., et al., Pali-x: On scaling up a multilingual vision and language model. arXiv preprint arXiv:2305.18565, 2023, Wei, J. et al., Finetuned language models are zero-shot learners, arXiv:2109.01652, 2021, or Lester, B., et al, The power of scale for parameter-efficient prompt tuning, arXiv:2104.08691, 2021.

The training system 100 generates the new neural network 110 from the pre-trained neural network 102 to perform one or more new machine learning tasks, e.g., in response to receiving input data for the one or more new machine learning tasks. For example, the training system 100 outputs data specifying the new neural network 110, e.g., data that includes trained values of parameters of the new neural network 110.

To generate the new neural network 110, the system 100 obtains multiple training examples 108. Each of the training examples 108 is a training example for one of the new machine learning tasks. For example, each training example can include a training input and a target output for the training input for a machine learning task. The target output for a given training input is the output that should be generated by the new neural network 110 by processing the given training input. For example, a training example for a visual question answering task can include a training input that includes an image and a text question about the image, and a target output that includes a text answer to the question.

The system 100 can generate the new neural network 110 by using a training engine 120 to train the new neural network 110 on the training examples 108.

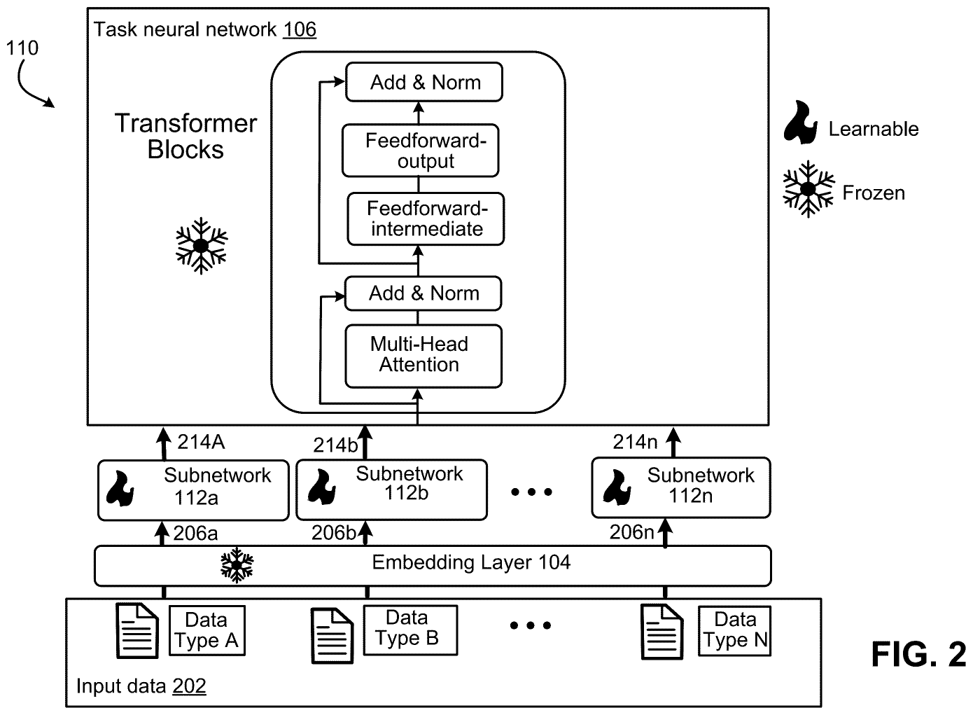

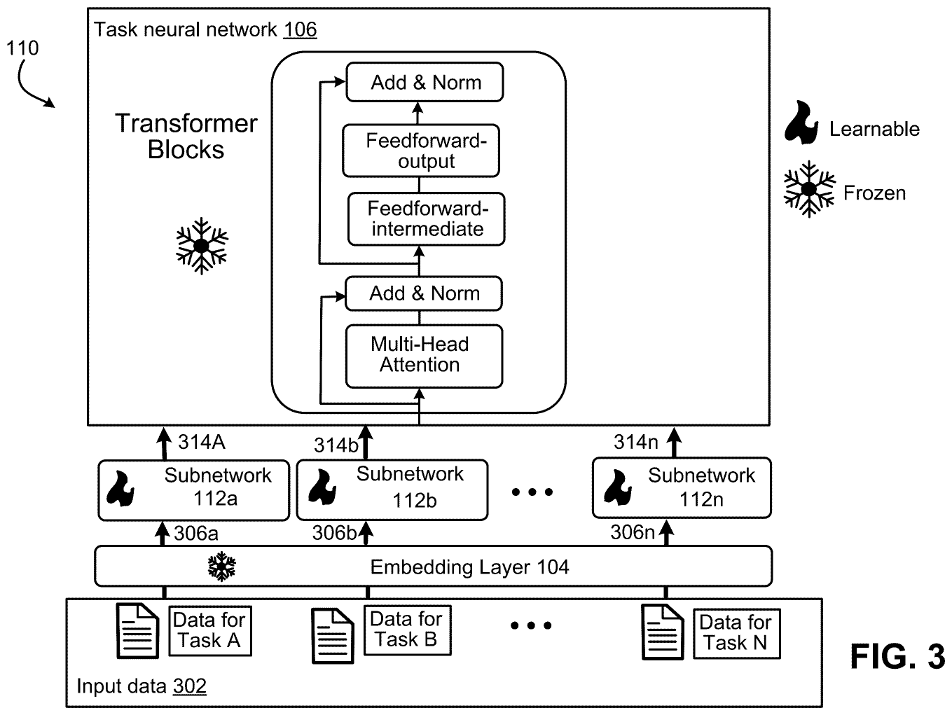

The new neural network 110 can include the embedding layer 104 and the task neural network 106 of the pre-trained neural network 102, and one or more subnetworks 112a-n. In some examples, as described with reference to FIG. 2, the new neural network 110 can include a subnetwork for each type of data. In some examples, as described with reference to FIG. 3, the new neural network 110 can include a subnetwork for each new machine learning task.

The system 100 can randomly initialize the parameters of one or more of the subnetworks. The training engine 120 can train the one or more subnetworks 112a-n while holding the embedding layer 104 and the task neural network 106 fixed. That is, instead of updating all of the parameters of the new neural network 110, the training engine 120 only updates the parameters of the subnetworks 112a-n and holds the parameters of the embedding layer 104 and the task neural network 106 fixed during the training.

The new neural network 110 thus includes the trained values of at least some of the parameters of the pre-trained neural network 102. For example, the new neural network 110 can include the trained values of the parameters of the embedding layer 104 and the task neural network 106.

For example, the training engine 120 can apply a gradient descent with backpropagation training technique that uses, e.g., a stochastic gradient descent, RMSprop, or Adam optimizer, or another known or learned optimizer, to optimize an objective function that is appropriate for the new machine learning task of the training examples 108. The exact forms of the objective function may vary across different tasks, but typically, the objective function measures a quality of the training output, e.g., that measures a difference between the training output of the new neural network 110 generated based on the training input of a training example and the known, target output (or another target output that is derived from the known, target output) of the training example. A cross-entropy loss function, e.g., in the case of classification tasks, and a mean squared error (MSE) loss function, e.g., in the case of regression tasks, are examples of suitable objective functions that can be used by the training engine 120 during the training.

At each training step of the training process, the training engine 120 processes a batch of training examples from the training examples 108 in accordance with the current values of the parameters to generate a training output for each pre-processed training example in the batch. The training engine 120 determines, with respect to the parameters of the new neural network 110, a gradient of an objective function that measures the overall quality of the training outputs generated by the new neural network 110 for the batch of training examples. At the end of each training step, the training engine 120 applies, e.g., through backpropagation, respective updates to at least some of the current values of the parameters of the new neural network 110 using the gradient determined at the training step.

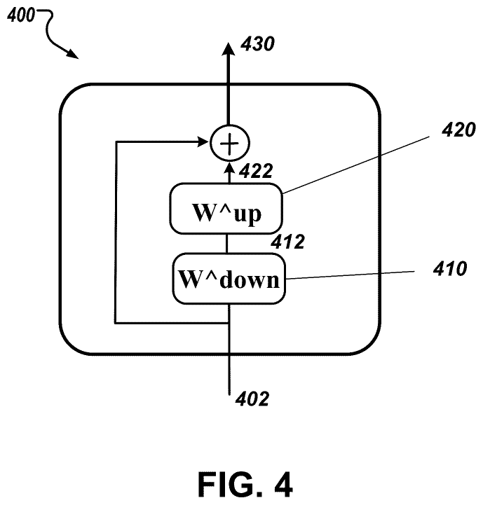

The subnetworks 112a-n are configured to receive the one or more embedded representations generated by the embedding layer 104. The subnetworks 112a-n are configured to generate one or more transformed embeddings that have the same dimensionality as the one or more embedded representations. The subnetworks 112a-n are configured to provide the one or more transformed embeddings as input to the task neural network 106. An example subnetwork is described below with reference to FIG. 4.

In some examples, each of the subnetworks can be associated with a different type of data. For example, some tasks such as visual question answering may require processing image data and text data. In this example, one subnetwork can be associated with image data, and another subnetwork can be associated with text data. An example new neural network 110 where each of the subnetworks 112a-n is associated with a different type of data is described below with reference to FIG. 2.

In some examples, each of the subnetworks 112a-n can be associated with a different machine learning task, such as different natural language understanding tasks or other tasks described below. An example new neural network 110 where each of the subnetworks 112a-n is associated with a different machine learning task is described below with reference to FIG. 3.

The pre-trained neural network 102 and the new neural network 110 can be configured through training to perform any kind of machine learning task, i.e., can be configured to receive any kind of digital data input and to generate any kind of digital data output based on the input. The new neural network 110 can be configured to process additional data inputs compared to the pre-trained neural network 102 to perform the one or more new machine learning tasks and generate appropriate outputs according to the one or more new tasks.

In some examples, the pre-trained neural network 102 can have been further trained using instruction tuning. For example, the pre-trained neural network 102 can have been fine tuned on training examples generated by the pre-trained neural network 102 to perform general tasks. An example process for further training the pre-trained neural network 102 is described in Wang et. al, Self-instruct: Aligning language model with self generated instructions, arXiv preprint arXiv:2212.10560 (2022). The general tasks can be less specific than the new tasks. As a particular example, if the pre-trained neural network 102 is a language model neural network, the general tasks can include long-form captioning, creative writing, or long-form question answering. The new tasks can include more specific downstream tasks that require specific skills such as understanding scene texts and documents, or answering knowledge intensive questions.

Some examples of machine learning tasks that the pre-trained neural network 102 or the new neural network 110 can be configured to perform follow.

In some cases, the neural network 102 or the new neural network 110 is a neural network that is configured to perform an image processing task, i.e., receive an input image and to process the input image to generate a network output for the input image. For example, the task may be image classification and the output generated by the neural network 102 or the new neural network 110 for a given image may be scores for each of a set of object categories, with each score representing an estimated likelihood that the image contains an image of an object belonging to the category. As another example, the task can be image embedding generation and the output generated by the neural network 102 or the new neural network 110 can be a numeric embedding of the input image. As yet another example, the task can be object detection and the output generated by the neural network 102 or the new neural network 110 can identify locations in the input image at which particular types of objects are depicted. As yet another example, the task can be image segmentation and the output generated by the neural network 102 or the new neural network 110 can assign each pixel of the input image to a category from a set of categories.

As another example, if the inputs to the neural network 102 or the new neural network 110 are Internet resources (e.g., web pages), documents, or portions of documents or features extracted from Internet resources, documents, or portions of documents, the task can be to classify the resource or document, i.e., the output generated by the neural network 102 or the new neural network 110 for a given Internet resource, document, or portion of a document may be a score for each of a set of topics, with each score representing an estimated likelihood that the Internet resource, document, or document portion is about the topic.

As another example, if the inputs to the neural network 102 or the new neural network 110 are features of an impression context for a particular advertisement, the output generated by the neural network 102 or the new neural network 110 may be a score that represents an estimated likelihood that the particular advertisement will be clicked on.

As another example, if the inputs to the neural network 102 or the new neural network 110 are features of a personalized recommendation for a user, e.g., features characterizing the context for the recommendation, e.g., features characterizing previous actions taken by the user, the output generated by the neural network 102 or the new neural network 110 may be a score for each of a set of content items, with each score representing an estimated likelihood that the user will respond favorably to being recommended the content item.

As another example, if the input to the neural network 102 or the new neural network 110 is a sequence of text in one language, the output generated by the neural network 102 or the new neural network 110 may be a score for each of a set of pieces of text in another language, with each score representing an estimated likelihood that the piece of text in the other language is a proper translation of the input text into the other language.

As another example, the task may be an audio processing task. For example, if the input to the neural network 102 or the new neural network 110 is a sequence representing a spoken utterance, the output generated by the neural network 102 or the new neural network 110 may be a score for each of a set of pieces of text, each score representing an estimated likelihood that the piece of text is the correct transcript for the utterance. As another example, the task may be a keyword spotting task where, if the input to the neural network 102 or the new neural network 110 is a sequence representing a spoken utterance, the output generated by the neural network 102 or the new neural network 110 can indicate whether a particular word or phrase (“hotword”) was spoken in the utterance. As another example, if the input to the neural network 102 or the new neural network 110 is a sequence representing a spoken utterance, the output generated by the neural network 102 or the new neural network 110 can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation. The agent can be, e.g., a real-world or simulated robot, a control system for an industrial facility, or a control system that controls a different kind of agent. Examples of environments and observations are described below.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the neural network 102 or the new neural network 110 is configured to perform multiple different individual machine learning tasks, e.g., two or more of the machine learning tasks mentioned above. For example, the neural network 102 or the new neural network 110 can be configured to perform multiple individual natural language understanding tasks, with the network input including an identifier for the individual natural language understanding task to be performed on the network input.

In some cases, the task is a multimodal task that requires processing multiple types or modalities of data. For example, the task can include receiving as input, or generating as output, or both, multiple types of data. In some examples, the neural network 102 and the new neural network 110 can include a multimodal language model neural network.

As a particular example, the task can include processing both text and image inputs. Examples of such tasks include open-vocabulary image classification, open-vocabulary object detection, image captioning, text-based image search, image-based retrieval, and so on. In some examples, the neural network 102 and the new neural network 110 include a computer vision neural network and a text processing neural network. That is, the target output to be generated by the computer vision neural network for a given image depends on one or more outputs generated by the text processing neural network for one or more corresponding text inputs (and vice versa).

FIG. 2 shows an example new neural network 110. In particular, the new neural network 110 includes subnetworks 112a-n that are each associated with a different type of data.

To generate an output for a machine learning task, the new neural network 110 receives input data 202 for the machine learning task. The input data 202 includes multiple types of data. As a particular example, the machine learning task can be a visual question-answering task. The new neural network 110 receives input data that includes an image x^{image} and a text question x^{text} about the image. In the example of FIG. 2, data type A is image data, and data type B is text data. Other example machine learning tasks include multimodal machine learning tasks such as an image captioning task, or a scene-text understanding task.

The new neural network 110 generates one or more embedded representations 206a-n for the input data 202 using the embedding layer 104. In the example of FIG. 2, each of the one or more embedded representations 206a-n corresponds to a type of data. For example, the embedding layer 104 generates an embedding representation 206a-n for each type of data in the input data 202. For example, the embedding layer 104 generates an embedded representation E_{image} 206a for the image data, and an embedded representation Eₜₑₓₜ 206b for the text data.

For example, the embedding layer 104 can generate the embedded representation E_{image} 206a for the image data using an image encoder neural network as described above with reference to FIG. 1. The embedding layer 104 can generate the embedded representation Eₜₑₓₜ 206b for the text data as described above with reference to FIG. 1.

The new neural network 110 processes the one or more embedded representations 206a-n using the subnetworks 112a-n. In the example of FIG. 2, each of the subnetworks 112a-n can be associated with a different type of data such as text data, image data, audio data, or video data. Each of the one or more subnetworks 112a-n is configured to receive an embedded representation 206a-n for a corresponding type of data, and to generate a transformed embedding 214a-n for the corresponding type of data. Each transformed embedding 214a-n has the same dimensionality as the embedded representation 206a-n for the corresponding type of data.

In the example of FIG. 2, the subnetwork 112a can be configured to process embedded representations for image data. For example, the subnetwork 112a generates a transformed embedding Ĕ_{image} 214a from embedded representation E_{image} 206a according to:

$${\tilde{E}}_{image} = {E}_{image} + f ( {E}_{image} \cdot {W}_{image}^{down} ) \cdot {W}_{image}^{up}$$

where w_{image}^{down} is a down projection matrix for the subnetwork 112a associated with image data, and w_{image}^{up} is an up projection matrix for the subnetwork 112a associated with image data.

The subnetwork 112b can be configured to process embedded representations for text data. For example, the subnetwork 112b generates a transformed embedding 214b from embedded representation Eₜₑₓₜ 206b according to:

$${\tilde{E}}_{text} = {E}_{text} + f ( {E}_{text} \cdot {W}_{text}^{down} ) \cdot {W}_{text}^{up}$$

where wₜₑₓₜ^{down} is a down projection matrix for the subnetwork 112b associated with text data, and wₜₑₓₜ^{up} is an up projection matrix for the subnetwork 112b associated with text data.

In the equations above, ƒ indicates a non-linear activation function. In some examples, the subnetworks 112 do not apply a non-linear activation function. An example subnetwork is described in further detail below with reference to FIG. 4.

The new neural network 110 provides the one or more transformed embeddings 214a-n as input to the task neural network 106. In some examples, the input to the task neural network 106 includes one or more transformed embeddings 214a-n that have been concatenated with each other. For example, the new neural network 110 can concatenate \tilde{E}_{image} and \tilde{E}ₜₑₓₜ a to generate the combined representation \tilde{E}={\tilde{E}ₜₑₓₜ}.

The task neural network 106 processes the one or more transformed embeddings 214a-n. For example, the task neural network 106 processes the combined representation. In the example of FIG. 2, the task neural network 106 is configured to process embedded representations of one or more types of data to generate the output. For example, the task neural network 106 can include a Transformer-based model with one or more Transformer blocks.

As described above with reference to FIG. 1, a training system can generate the new neural network 110 from a pre-trained neural network. In some examples, the pre-trained neural network can include a vision language model or other multimodal model. In the example of FIG. 2, the pre-trained neural network can include a PaLI-X (Chen et al. arXiv:2305.18565) model. In this example, the embedding layer 104 includes a Vision Transformer (ViT) and a SentencePiece tokenizer as described above with reference to FIG. 1, and the task neural network 106 has an encoder-decoder Transformer-based architecture.

Each of the subnetworks 112a-n can have been trained to process a different type of data. For example, as described above with reference to FIG. 1, the training system can train the subnetworks 112a-n while holding the embedding layer 104 and the task neural network 106 of the pre-trained neural network fixed.

By including a subnetwork 112a-n for each type of data, the new neural network 110 can provide targeted adaptation for different modalities of data, while isolating interference across modalities. In some examples, the new neural network 110 allows the modality representations to be handled independently for greater flexibility. For example, the data of different modalities can be stored or processed separately before being combined into the combined representation. As another example, data of different modalities can be fused at different levels. For example, different modalities of data can have different depths. As a particular example, the image encoder neural network can be a deep neural network with many layers, or a shallow neural network. Independently, the text encoder can be a deep neural network or a shallow neural network. Thus the new neural network 110 can generate a combined representation that includes data of different modalities at different levels of processing.

FIG. 3 shows another example new neural network 110. In particular, the new neural network 110 includes subnetworks 112a-n that each correspond to a particular machine learning task.

To generate an output for a machine learning task, the new neural network 110 receives input data 302 for the machine learning task. In the example of FIG. 3, the machine learning task, task A, can be a natural language inference task such as multi-genre natural language inference or question-answering natural language inference. The new neural network 110 receives input data 302 that includes text data for the natural language inference task. Other example machine learning tasks include a sentiment task, a reading comprehension task, a commonsense reasoning task, a paraphrase task, a closed-book question answering task, a coreference task, a grammaticality task, a semantic similarity task, or a textual entailment task.

The new neural network 110 generates one or more embedded representations 306a-n for the input data 302 using the embedding layer 104. For example, the embedding layer 104 generates an embedded representation 306a for the input data corresponding to the task A.

As an example, the embedding layer 104 can generate the embedded representation 306a for the input data 302 by processing the text data of the input data 302 as described above with reference to FIG. 1.

The new neural network 110 processes the one or more embedded representations 306a-n using the subnetworks 112a-n. In the example of FIG. 3, each of the subnetworks 112a-n can correspond to a particular machine learning task. Each of the one or more subnetworks 112a-n is configured to receive an embedded representation 306a-n for input data that corresponds to the particular machine learning task for the subnetwork, and to generate a transformed embedding 314a-n for the embedded representation for input data that corresponds to the particular machine learning task. Each transformed embedding 314a-n has the same dimensionality as the embedded representation 306a-n for input data that corresponds to the particular machine learning task.

In the example of FIG. 3, the subnetwork 112a can be configured to process embedded representations for input data corresponding to the natural language inference task. For example, the subnetwork 112a generates a transformed embedding 314a from embedded representation 306a.

The new neural network 110 provides the one or more transformed embeddings 314a-n as input to the task neural network 106. For example, the neural network 110 provides the transformed embedding 314a as input to the task neural network 106.

The task neural network 106 processes the one or more transformed embeddings 314a-n. For example, the task neural network 106 processes the transformed embedding 314a. In the example of FIG. 3, the task neural network 106 is configured to process embedded representations to generate the output. For example, the task neural network 106 can include a Transformer-based model with one or more Transformer blocks.

As described above with reference to FIG. 1, a training system can generate the new neural network 110 from a pre-trained neural network. In some examples, the pre-trained neural network can include a large language model, or a diffusion model. In the example of FIG. 3, the pre-trained neural network can include a FLAN (Wei et al. arXiv:2109.01652) model. In this example, the embedding layer 104 includes a SentencePiece tokenizer, and the task neural network 106 has a decoder-only Transformer-based architecture.

Each of the subnetworks 112a-n can have been trained to process input data for a different machine learning task. For example, as described above with reference to FIG. 1, the training system can train the subnetworks 112a-n while holding the embedding layer 104 and the task neural network 106 of the pre-trained neural network fixed.

By including a subnetwork 112a-n for each machine learning task, the new neural network 110 can provide for flexibility in the granularity of task adaptation. For example, in multi-task learning scenarios, the new neural network 110 can include a subnetwork for each task. During training of the new neural network 110, the embedded representations for input training data for a task are selectively transformed by the task-specific subnetwork. At inference, the new neural network 110 uses the task-specific subnetwork to elicit adapted behavior for the task. The rest of the model remains unchanged, avoiding negative interference. Thus the new neural network 110 targets adaptation to the nuances of each task while enabling positive knowledge transfer through the shared parameters.

FIG. 4 shows an example subnetwork 400. The subnetwork 400 is an example of the subnetworks described above with reference to FIG. 1.

The subnetwork 400 is configured to generate a particular transformed embedding 430 for a corresponding embedded representation 402. For example, as described above with reference to FIG. 2, the subnetwork 400 can be associated with a corresponding type of data. The corresponding embedded representation 402 can be an embedded representation for the corresponding type of data.

As another example, as described above with reference to FIG. 3, the subnetwork 400 can correspond to a particular machine learning task. The corresponding embedded representation 402 can be an embedded representation for input data that corresponds to the particular machine learning task.

To generate the transformed embedding 430, the subnetwork 400 receives the embedded representation 402, e.g., generated by the embedding layer described above with reference to FIGS. 1-3.

The subnetwork 400 includes multiple fully connected layers, such as a “W\hat{ }down” layer 410 and a “W\hat{ }up” layer 420.

The subnetwork 400 can use the layer 410 to project the corresponding embedded representation 402 into a low-dimension representation 412. The low-dimension representation 412 has lower dimensionality than the corresponding embedded representation 402. For example, the layer 410 performs a down projection with down projection matrix w^{down}, where [symbol] ^{dōwn} ∈ [symbol] ^{d}^{_{emb}}^{×r}, to project the embedded representation 402 which has a dimensionality of d_{emb} into the low-dimension representation 412 which has a dimensionality of r, also referred to as the bottleneck dimension.

In some examples, the subnetwork 400 applies a nonlinear activation function to the low-dimension representation 412 prior to using the layer 420 to project the low-dimension representation 412 into a high-dimension representation 422.

The subnetwork 400 can use the layer 420 to project the low-dimension representation 412 into a high-dimension representation 422. The high-dimension representation 422 has a same dimensionality as the corresponding embedded representation 402. For example, the layer 420 performs an up projection with up projection matrix w^{up}, where [symbol] ^{up} ∈ [symbol] ^{r×d}^{_{emb}}, to project the low-dimension representation 412 which has a dimensionality of r into the high-dimension representation 422, which has a dimensionality of d_{emb}.

The subnetwork 400 can generate the particular transformed embedding 430 for the corresponding embedded representation 402 by combining the corresponding embedded representation 402 with the high-dimension representation 422. For example, the subnetwork 400 can add the embedded representation 402 and the high-dimension representation 422.

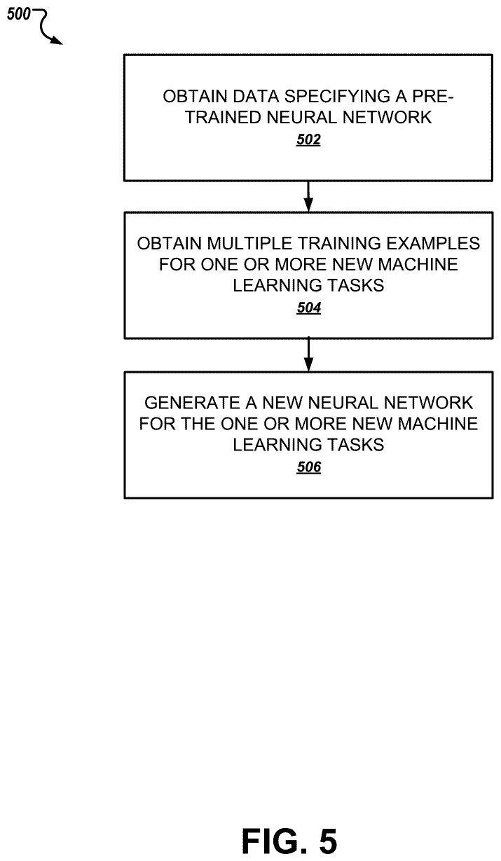

FIG. 5 is a flow diagram of an example process for generating a new neural network. For convenience, the process 500 will be described as being performed by a system of one or more computers located in one or more locations. For example, a training system, e.g., the training system 100 of FIG. 1, appropriately programmed in accordance with this specification, can perform the process 500.

The system obtains data specifying a pre-trained neural network (step 502). The pre-trained neural network has been pre-trained to perform one or more machine learning tasks.

The pre-trained neural network includes an embedding layer and a task neural network. The pre-trained neural network is configured to receive input data for the one or more machine learning tasks. The pre-trained neural network generates one or more embedded representations for the input data using the embedding layer. The pre-trained neural network processes an input sequence that includes the one or more embedded representations using the task neural network to generate an output for the one or more machine learning tasks. An example pre-trained neural network with an embedding layer and a task neural network is described above with reference to FIG. 1. In some examples, the pre-trained neural network can have been trained using instruction tuning.

The system obtains multiple training examples for one or more new machine learning tasks (step 504). For example, each training example includes a training input and a target output for one of the new machine learning tasks.

The system generates a new neural network for the one or more new machine learning tasks (step 506). The new neural network includes one or more subnetworks, the embedding layer, and the task neural network. For example, the system trains the new neural network on the multiple training examples by training the one or more subnetworks while holding the embedding layer and the task neural network fixed.

Each subnetwork is configured to generate a particular transformed embedding for a corresponding embedded representation. Each subnetwork can include two fully connected layers. An example subnetwork is described in more detail above with reference to FIG. 4.

The one or more subnetworks are configured to receive the one or more embedded representations. The one or more subnetworks generate one or more transformed embeddings that have the same dimensionality as the one or more embedded representations. The one or more subnetworks provide the one or more transformed embeddings as input to the task neural network.

In some implementations, each of the subnetworks is configured to receive an embedded representation for a corresponding type of data. For example, the input data includes multiple types of data such as text data, image data, audio data, or video data. In these implementations, each of the embedded representations corresponds to a type of data. In some examples, the pre-trained neural network can include a vision language model or a multimodal model.

Each of the subnetworks is configured to generate a transformed embedding for the corresponding type of data. The input to the task neural network includes one or more transformed embeddings that have been concatenated with each other.

In some implementations, each of the subnetworks corresponds to a particular machine learning task of the new machine learning tasks. Each of the subnetworks is configured to receive an embedded representation for input data that corresponds to a particular machine learning task. Each of the subnetworks is configured to generate a transformed embedding for the embedded representation for input data that corresponds to the particular machine learning task. In some examples, the pre-trained neural network can include a large language model or a diffusion model.

The system can thus provide for configurable serving. For example, the subnetworks can be intermediate processing units that generate transformed embeddings for embedded representations. The system can provide the transformed embedding as input to the task neural network.

As another example, the subnetworks can directly transform vocabulary embeddings. For example, the subnetworks can receive vocabulary embeddings and apply a linear transformation to the vocabulary embeddings. An example is described above with reference to FIG. 2.

Examples of environments and observations for when the classification task is an agent control task now follow.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements, e.g., steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation, e.g., steering, and movement, e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material, e.g., to remove pollutants, to generate a cleaned or recycled product. The manufacturing plant may comprise a plurality of manufacturing units such as vessels for chemical or biological substances, or machines, e.g., robots, for processing solid or other materials. The manufacturing units are configured such that an intermediate version or component of the product is moveable between the manufacturing units during manufacture of the product, e.g., via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g., minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment, e.g., between the manufacturing units or machines. In general the actions may be any actions that have an effect on the observed state of the environment, e.g., actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g., a metric of a quantity of energy, materials, or other resources, used to perform the task. In the case of a task that is to control use a resource the metric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g., sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions, e.g., a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g., data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control, e.g., cooling equipment, or air flow control or air conditioning equipment. The task may comprise a task to control, e.g., minimize, use of a resource, such as a task to control electrical power consumption, or water consumption. The agent may comprise an electronic agent configured to control operation of the items of equipment, or to control operation of the ancillary, e.g., environmental, control equipment.

In general the actions may be any actions that have an effect on the observed state of the environment, e.g., actions configured to adjust any of the sensed parameters described below. These may include actions to control, or to impose operating conditions on, the items of equipment or the ancillary control equipment, e.g., actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g., minimize, use of a resource, such as a task to control use of electrical power or water, the metric may comprise any metric of use of the resource.

In some implementations the environment is the real-world environment of a power generation facility, e.g., a renewable power generation facility such as a solar farm or wind farm. The task may comprise a control task to control power generated by the facility, e.g., to control the delivery of electrical power to a power distribution grid, e.g., to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements, e.g., to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g., an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid, e.g., from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmachemical drug and the agent is a computer system for determining elements of the pharmachemical drug and/or a synthetic pathway for the pharmachemical drug. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources, e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g., an environment in which the design of an electrical, mechanical or electro-mechanical entity is simulated. The simulated environment may be a simulation of a real-world environment in which the entity is intended to work. The task may be to design the entity. The observations may comprise observations that characterize the entity, i.e., observations of a mechanical shape or of an electrical, mechanical, or electro-mechanical configuration of the entity, or observations of parameters or properties of the entity. The actions may comprise actions that modify the entity, e.g., that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g., in the form of computer executable instructions for manufacturing the entity. The process may include making the entity according to the design. Thus a design an entity may be optimized, e.g., by reinforcement learning, and then the optimized design output for manufacturing the entity, e.g., as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a key vectorboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
obtaining data specifying a pre-trained neural network, wherein the pre-trained neural network comprises an embedding layer and a task neural network, wherein the pre-trained neural network has been pre-trained to perform one or more machine learning tasks, and wherein the pre-trained neural network is configured to:
receive input data;
generate one or more embedded representations for the input data using the embedding layer;
process an input sequence comprising the one or more embedded representations using the task neural network to generate an output for the one or more machine learning tasks;
obtaining a plurality of training examples for one or more new machine learning tasks;
generating a new neural network for the one or more new machine learning tasks, wherein the new neural network comprises one or more subnetworks, the embedding layer, and the task neural network, and wherein the one or more subnetworks are configured to:
receive the one or more embedded representations;
generate one or more transformed embeddings that have the same dimensionality as the one or more embedded representations; and
provide the one or more transformed embeddings as input to the task neural network, and wherein generating the new neural network comprises training the new neural network on the plurality of training examples by training the one or more subnetworks while holding the embedding layer and the task neural network fixed.

2. The method of claim 1, wherein the input data comprises a plurality of types of data, and wherein each of the one or more embedded representations corresponds to a type of data, and wherein each of the one or more subnetworks is configured to generate a transformed embedding for a corresponding type of data, and wherein each of the one or more subnetworks is configured to receive the embedded representation for the corresponding type of data.

3. The method of claim 1, wherein the input to the task neural network comprises one or more transformed embeddings that have been concatenated with each other.

4. The method of claim 2, wherein the plurality of types of data comprise: text data, image data, audio data, or video data.

5. The method of claim 2, wherein the new machine learning task comprises any one of:
a visual question-answering task, an image captioning task, or a scene-text understanding task.

6. The method of claim 2, wherein the pre-trained neural network is any one of: a vision language model, or a multimodal model.

7. The method of claim 1, wherein each of the one or more subnetworks corresponds to a particular machine learning task of the one or more new machine learning tasks, and wherein each of the one or more subnetworks is configured to generate a transformed embedding for an embedded representation for input data that corresponds to the particular machine learning task, and wherein each of the one or more subnetworks is configured to receive the embedded representation for input data that corresponds to the particular machine learning task.

8. The method of claim 7, wherein the one or more new machine learning tasks comprise:
a natural language inference task, a sentiment task, a reading comprehension task, a commonsense reasoning task, a paraphrase task, a closed-book question answering task, or a coreference task.

9. The method of claim 7, wherein the pre-trained neural network is any one of: a large language model, or a diffusion model.

10. The method of claim 1, wherein each of the one or more subnetworks comprise two fully connected layers.

11. The method of claim 1, wherein the pre-trained neural network has been trained using instruction tuning.

12. The method of claim 1, wherein the embedding layer comprises any one or more of: a convolutional neural network, a Transformer neural network, or a vision Transformer (ViT) neural network.

13. The method of claim 1, wherein each of the one or more subnetworks is configured to generate a particular transformed embedding for a corresponding embedded representation, and wherein each of the one or more subnetworks is configured to:
project the corresponding embedded representation into a low-dimension representation, wherein the low-dimension representation has lower dimensionality than the corresponding embedded representation;
project the low-dimension representation into a high-dimension representation, wherein the high-dimension representation has a same dimensionality as the corresponding embedded representation; and
generate the particular transformed embedding for the corresponding embedded representation by combining the corresponding embedded representation with the high-dimension representation.

14. The method of claim 1, wherein the input data comprises image data, and the embedding layer is configured to:
for each image in the image data:
resize the image to a particular resolution;
separate the resized image into a plurality of non-overlapping patches;
obtain a respective visual token for each non-overlapping patch;
provide each respective visual token to a visual neural network that generates output tokens for the respective visual tokens; and
generate a respective embedded representation for the image by flattening the output tokens from the visual neural network.

15. The method of claim 1, wherein the input data comprises text data, and the embedding layer is configured to:
obtain a sequence of tokens that represent the text data; and
generate the embedded representation by obtaining an embedding for each token in the sequence of tokens.

16. A system comprising:
one or more computers; and
one or more storage devices storing instructions that, when executed by the one or more computers, cause the one or more computers to perform operations comprising:
obtaining data specifying a pre-trained neural network, wherein the pre-trained neural network comprises an embedding layer and a task neural network, wherein the pre-trained neural network has been pre-trained to perform one or more machine learning tasks, and wherein the pre-trained neural network is configured to:
receive input data;
generate one or more embedded representations for the input data using the embedding layer;
process an input sequence comprising the one or more embedded representations using the task neural network to generate an output for the one or more machine learning tasks;
obtaining a plurality of training examples for one or more new machine learning tasks;
generating a new neural network for the one or more new machine learning tasks, wherein the new neural network comprises one or more subnetworks, the embedding layer, and the task neural network, and wherein the one or more subnetworks are configured to:
receive the one or more embedded representations;
generate one or more transformed embeddings that have the same dimensionality as the one or more embedded representations; and
provide the one or more transformed embeddings as input to the task neural network, and wherein generating the new neural network comprises training the new neural network on the plurality of training examples by training the one or more subnetworks while holding the embedding layer and the task neural network fixed.

17. The system of claim 16, wherein the input data comprises a plurality of types of data, and wherein each of the one or more embedded representations corresponds to a type of data, and wherein each of the one or more subnetworks is configured to generate a transformed embedding for a corresponding type of data, and wherein each of the one or more subnetworks is configured to receive the embedded representation for the corresponding type of data.

18. The system of claim 16, wherein each of the one or more subnetworks corresponds to a particular machine learning task of the one or more new machine learning tasks, and wherein each of the one or more subnetworks is configured to generate a transformed embedding for an embedded representation for input data that corresponds to the particular machine learning task, and wherein each of the one or more subnetworks is configured to receive the embedded representation for input data that corresponds to the particular machine learning task.

19. The system of claim 16, wherein each of the one or more subnetworks is configured to generate a particular transformed embedding for a corresponding embedded representation, and wherein each of the one or more subnetworks is configured to:
project the corresponding embedded representation into a low-dimension representation, wherein the low-dimension representation has lower dimensionality than the corresponding embedded representation;
project the low-dimension representation into a high-dimension representation, wherein the high-dimension representation has a same dimensionality as the corresponding embedded representation; and
generate the particular transformed embedding for the corresponding embedded representation by combining the corresponding embedded representation with the high-dimension representation.

20. One or more computer-readable storage media storing instructions that when executed by one or more computers cause the one or more computers to perform operations comprising:
obtaining data specifying a pre-trained neural network, wherein the pre-trained neural network comprises an embedding layer and a task neural network, wherein the pre-trained neural network has been pre-trained to perform one or more machine learning tasks, and wherein the pre-trained neural network is configured to:
receive input data;
generate one or more embedded representations for the input data using the embedding layer;
process an input sequence comprising the one or more embedded representations using the task neural network to generate an output for the one or more machine learning tasks;
obtaining a plurality of training examples for one or more new machine learning tasks;
generating a new neural network for the one or more new machine learning tasks, wherein the new neural network comprises one or more subnetworks, the embedding layer, and the task neural network, and wherein the one or more subnetworks are configured to:
receive the one or more embedded representations;
generate one or more transformed embeddings that have the same dimensionality as the one or more embedded representations; and
provide the one or more transformed embeddings as input to the task neural network, and wherein generating the new neural network comprises training the new neural network on the plurality of training examples by training the one or more subnetworks while holding the embedding layer and the task neural network fixed.
